(19) United States
(12) Patent Application Publication
(10) Pub. No.: US 2026/0064225 A1
(43) Pub. Date: Mar. 5, 2026

(54) Systems and Methods for On-Cell Touch Off-State Pattern Visibility Mitigation

(71) Applicant: Apple Inc., Cupertino, CA (US)

(72) Inventors: Jonathan H Beck, San Francisco, CA (US); Yurii Morozov, Los Altos, CA (US); Warren S Rieutort-Louis, Cupertino, CA (US); Sebastian Knitter, San Francisco, CA (US); Ambikaa Jaggi, Cupertino, CA (US); Sagar R Vaze, Santa Clara, CA (US); Hongwoo Jang, San Diego, CA (US); Isaac W Chan, San Jose, CA (US); Jiun-Jye Chang, Cupertino, CA (US); Nikhil Dole, Castro Valley, CA (US)

(21) Appl. No.: 19/292,884

(22) Filed: Aug. 6, 2025

Related U.S. Application Data
(60) Provisional application No. 63/690,291, filed on Sep. 3, 2024.

(51) Int. Cl. G06F 3/041; G06F 3/044

(52) U.S. Cl. CPC G06F 3/0418; G06F 3/0412; G06F 3/044; G06F 2203/04111; G06F 2203/04112

(57) ABSTRACT

An electronic display may include both a display subsystem and a touch subsystem. Opaque metal layers used in on-cell touch sensor technology of the touch subsystem may cause undesirable visual artifacts. Visual artifacts caused by the cuts in the touch metal mesh may be reduced or eliminated by disposing a metal patch on a different layer than the metal mesh to increase reflected light, presenting a more uniform appearance to the user. Visual artifacts caused by a bridge disposed across the metal mesh may be reduced or eliminated by curving or angling the geometry of the bridge across the metal mesh or by disposing a metal cladding (e.g., covering) above the bridge. Visual artifacts caused by functional vias disposed in a net of the touch subsystem may be reduced or eliminated by disposing non-functional vias and/or non-functional holes in the net.

### CROSS-REFERENCE TO RELATED APPLICATIONS

This patent application claims the benefit of U.S. Provisional Patent Application 63/690,291, entitled “Systems and Methods for On-Cell Touch Off-State Pattern Visibility Mitigation” filed Sep. 3, 2024, which is hereby incorporated by reference.

### SUMMARY

This disclosure relates to mitigating front-of-screen image artifacts for touch displays and, more specifically, to mitigating front-of-screen image artifacts caused by a touch metal mesh during an off-state of an electronic device.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (μLEDs). By causing different display pixels to emit different amounts of light, individual display pixels of an electronic display may collectively produce images.

An electronic display may include both a display subsystem and a touch subsystem, such as in an integrated panel or system-on-a-chip (SOC). Opaque metal layers used in on-cell touch sensor technology of the touch subsystem may cause undesirable off-state front-of-screen issues (e.g., unwanted visual artifacts) that may negatively impact user experience. These visual artifacts may be due to cuts in a touch metal mesh of the touch subsystem, a bridge disposed across the metal mesh, or vias disposed in nets.

Cuts (e.g., gaps) in a touch metal mesh may be made to electrically isolate nets in a touch active area. However, these cuts (e.g., gaps) in the metal mesh may result in visual artifacts perceptible by a user of the electronic device, as less light is reflected at the respective location of each cut, which may negatively impact user experience. These visual artifacts may be reduced or eliminated by disposing a metal patch on a different layer than the metal mesh to increase reflected light, presenting a more uniform appearance to the user. For example, for cuts on a lower layer metal mesh (e.g., TM1 layer), a metal patch may be disposed over the cuts on an upper layer metal mesh (e.g., TM2 layer) to enhance uniform reflectivity and reduce or eliminate the visual artifacts caused by the cuts in the TM1 metal mesh. As another example, a metal patch may be disposed beneath cuts in a metal mesh on the TM2 layer to enhance uniform reflectivity and reduce or eliminate the visual artifacts caused by the cuts in the TM2 metal mesh.

Visual artifacts caused by a bridge disposed across the metal mesh may be reduced or eliminated by curving or angling the geometry of the bridge across the metal mesh such that the bridge may reflect incident light in multiple directions not directly in the line of sight of a user of the electronic device, reducing or eliminating a visual artifact that may be present in a straight-line bridge that reflects incident light in the same direction. Additionally or alternatively, visual artifacts caused by the bridge may be reduced or eliminated by disposing a metal cladding (e.g., covering) above the bridge.

Visual artifacts caused by functional vias disposed in a net of the touch subsystem may be reduced or eliminated by disposing dummy vias (e.g., non-functional vias) and/or dummy holes (e.g., non-functional holes) in the net to enhance the uniformity of the light reflected back to the user of the electronic device. Vias disposed in a border of an active region (e.g., a border between the active region and an inactive region) may cause visible diffraction patterns that may negatively impact user experience. To reduce or eliminate the diffraction pattern, the vias may be disposed in an irregular (e.g., non-uniform, random) pattern. It should be noted that any of the systems and methods to reduce or eliminate visual patterns described above may be used alone or in combination with each other.

### BRIEF DESCRIPTION OF THE DRAWINGS

Various aspects of this disclosure may be better understood upon reading the following detailed description and upon reference to the drawings described below.

FIG. 1 is a schematic block diagram of an electronic device, in accordance with an embodiment;

FIG. 2 is a front view of a mobile phone representing an example of the electronic device of FIG. 1, in accordance with an embodiment;

FIG. 3 is a front view of a tablet device representing an example of the electronic device of FIG. 1, in accordance with an embodiment;

FIG. 4 is a front view of a notebook computer representing an example of the electronic device of FIG. 1, in accordance with an embodiment;

FIG. 5 are front and side views of a watch representing an example of the electronic device of FIG. 1, in accordance with an embodiment;

FIG. 6 is another example of the electronic device of FIG. 1 in the form of a computer, in accordance with an embodiment;

FIG. 7 is a block diagram of a display pixel array of the electronic display of FIG. 1, in accordance with an embodiment;

FIG. 8 is a block diagram of a touch sensor array of the electronic display of FIG. 1, in accordance with an embodiment;

FIG. 9 illustrates a touch metal mesh with metal mesh cuts (e.g., gaps);

FIG. 10 illustrates a touch metal layer 2 (TM2) trace with a touch metal layer 1 (TM1) patch disposed beneath to reduce the reflected light differential in accordance with an embodiment;

FIG. 11 is a diagram illustrating a side view of the TM1 patch disposed beneath the cut in the TM2 trace, in accordance with an embodiment;

FIG. 12 illustrates a TM1 mesh having a TM2 patch disposed above the TM1 mesh to enhance reflected light uniformity for the TM1 mesh, in accordance with an embodiment;

FIG. 13 is a diagram illustrating a side view of the TM2 patch disposed above the cut in a TM1 trace of the TM1 mesh, in accordance with an embodiment;

FIG. 14 illustrates a corner cut made onto a curved portion of the metal mesh to reduce or eliminate a visible screen artifact, in accordance with an embodiment;

FIG. 15 is a diagram of a sensor mesh of a first metal layer and a curved bridge of a second metal layer, in accordance with an embodiment;

FIG. 16 illustrates a curved bridge having curves with a circular geometry, in accordance with an embodiment;

FIG. 17 illustrates a bridge having curves with an angular geometry, in accordance with an embodiment;

FIG. 18 is a diagram illustrating how reflected light from an uncladded (e.g., uncovered) TM1 bridge may be visible to a user;

FIG. 19 is a diagram illustrating how reflected light off of a bridge may be reduced or eliminated by cladding, in accordance with an embodiment;

FIG. 20 is a diagram illustrating a top view of the TM2 cladding disposed over the TM1 bridge in accordance with an embodiment;

FIG. 21 is a diagram illustrating another top view of the TM2 cladding disposed over the TM1 bridge, in accordance with an embodiment;

FIG. 22 is a diagram illustrating cladding disposed across the electronic display, not merely over portions of the TM1 bridge, in accordance with an embodiment;

FIG. 23 is a diagram illustrating a patterned inter-layer dielectric (ILD) disposed beneath the TM2 bridge to bring the TM2 bridge onto the TM1 metal layer, reducing or eliminating a bright off-state appearance of the TM2 bridge, in accordance with an embodiment;

FIG. 24 is a diagram illustrating the implementation of dummy vias to reduce or eliminate the appearance of visual artifacts due to functional vias, in accordance with an embodiment;

FIG. 25 is a diagram illustrating the implementation of dummy holes to reduce or eliminate the appearance of visual artifacts due to functional vias, in accordance with an embodiment; and

FIG. 26 illustrates an irregular pattern (e.g., a non-uniform pattern, a randomized pattern) of vias disposed at the active area border and the inactive area of the electronic device described with respect to FIG. 1, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

The present disclosure provides systems and methods for reducing or eliminating visual artifacts associated with or caused by a touch subsystem of an electronic device. Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (μLEDs). By causing different display pixels to emit different amounts of light, individual display pixels of an electronic display may collectively produce images.

An electronic display may include both a display subsystem and a touch subsystem, such as in an integrated panel or system-on-a-chip (SOC). Opaque metal layers used in on-cell touch sensor technology of the touch subsystem may cause undesirable off-state front-of-screen issues (e.g., unwanted visual artifacts) that may negatively impact user experience. These visual artifacts may be due to cuts in a touch metal mesh of the touch subsystem, a bridge disposed across the metal mesh, or vias disposed in nets. While in some scenarios transparent metal layers may be used instead of opaque metal layers, transparent metals may not conduct electricity as well as certain opaque metals.

Cuts (e.g., gaps) in a touch metal mesh may be made to electrically isolate nets in a touch active area. However, these cuts (e.g., gaps) in the metal mesh may result in visual artifacts perceptible by a user of the electronic device, as less light is reflected at the respective location of each cut, which may negatively impact user experience. These visual artifacts may be reduced or eliminated by disposing a metal patch on a different layer than the metal mesh to increase reflected light, presenting a more uniform appearance to the user. For example, for cuts on a lower layer metal mesh (e.g., TM1 layer), a metal patch may be disposed over the cuts on an upper layer metal mesh (e.g., TM2 layer) to enhance uniform reflectivity and reduce or eliminate the visual artifacts caused by the cuts in the TM1 metal mesh. As another example, a metal patch may be disposed beneath cuts in a metal mesh on the TM2 layer to enhance uniform reflectivity and reduce or eliminate the visual artifacts caused by the cuts in the TM2 metal mesh.

Visual artifacts caused by a bridge disposed across the metal mesh may be reduced or eliminated by curving or angling the geometry of the bridge across the metal mesh such that the bridge may reflect incident light in multiple directions not directly in the line of sight of a user of the electronic device, reducing or eliminating a visual artifact that may be present in a straight-line bridge that reflects incident light in the same direction. Additionally or alternatively, visual artifacts caused by the bridge may be reduced or eliminated by disposing a metal cladding (e.g., covering) above the bridge.

Visual artifacts caused by functional vias disposed in a net of the touch subsystem may be reduced or eliminated by disposing dummy vias (e.g., non-functional vias) and/or dummy holes (e.g., non-functional holes) in the net to enhance the uniformity of the light reflected back to the user of the electronic device. Vias disposed in a border of an active region (e.g., a border between the active region and an inactive region) may cause visible diffraction patterns that may negatively impact user experience. To reduce or eliminate the diffraction pattern, the vias may be disposed in an irregular (e.g., non-uniform, random) pattern. It should be noted that any of the systems and methods to reduce or eliminate visual patterns described above may be used alone or in combination with each other.

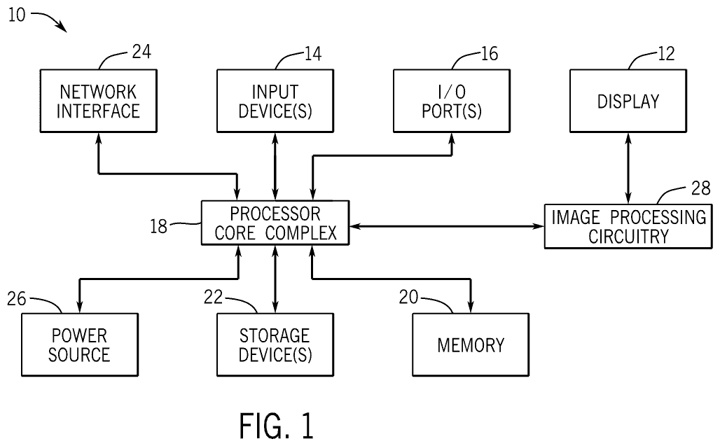

With this in mind, an example of an electronic device 10, which includes an electronic display 12 that may benefit from these features, is shown in FIG. 1. FIG. 1 is a schematic block diagram of the electronic device 10. The electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

In addition to the electronic display 12, as depicted, the electronic device 10 includes one or more input devices 14, one or more input/output (I/O) ports 16, a processor core complex 18 having one or more processors or processor cores and/or image processing circuitry, memory 20, one or more storage devices 22, a network interface 24, a power supply 26, and image processing circuitry 28. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the memory 20 and the storage devices 22 may be included in a single component. Additionally or alternatively, image processing circuitry of the processor core complex 18 may be disposed as a separate module or may be disposed within the electronic display 12.

The processor core complex 18 is operably coupled with the memory 20 and the storage device 22. As such, the processor core complex 18 may execute instructions stored in memory 20 and/or a storage device 22 to perform operations, such as generating or processing image data. The processor core complex 18 may include one or more microprocessors, one or more application specific processors (ASICs), one or more field programmable logic arrays (FPGAs), or any combination thereof.

In addition to instructions, the memory 20 and/or the storage device 22 may store data, such as image data. Thus, the memory 20 and/or the storage device 22 may include one or more tangible, non-transitory, computer-readable media that store instructions executable by processing circuitry, such as the processor core complex 18, and/or data to be processed by the processing circuitry. For example, the memory 20 may include random access memory (RAM) and the storage device 22 may include read only memory (ROM), rewritable non-volatile memory, such as flash memory, hard drives, optical discs, and/or the like.

The network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a 4th Generation (4G), Long-Term Evolution (LTE), or 5th Generation (5G) cellular network. In other words, the network interface 24 may enable the electronic device 10 to transmit data (e.g., image data) to a communication network and/or receive data from the communication network.

The power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter. A power management integrated circuit (PMIC) may control the provision and generation of electrical power to the various components of the electronic device 10.

The I/O ports 16 may enable the electronic device 10 to interface with another electronic device 10. For example, a portable storage device may be connected to an I/O port 16, thereby enabling the electronic device 10 to communicate data, such as image data, with the portable storage device.

The input devices 14 may enable a user to interact with the electronic device 10. For example, the input devices 14 may include one or more buttons, one or more keyboards, one or more mice, one or more trackpads, and/or the like. Additionally, the input devices 14 may include touch sensing components implemented in the electronic display 12. The touch sensing components may receive user inputs by detecting occurrence and/or position of an object contacting the display surface of the electronic display 12.

In addition to enabling user inputs, the electronic display 12 may provide visual representations of information by displaying one or more images (e.g., image frames or pictures). For example, the electronic display 12 may display a graphical user interface (GUI) of an operating system, an application interface, text, a still image, or video content. To facilitate displaying images, the electronic display 12 may include a display panel with one or more display pixels. The display pixels may represent sub-pixels that each control a luminance of one color component (e.g., red, green, or blue for a red-green-blue (RGB) pixel arrangement).

The electronic display 12 may display an image by controlling the luminance of its display pixels based at least in part image data associated with corresponding image pixels in image data. In some embodiments, the image data may be generated by an image source, such as the processor core complex 18, a graphics processing unit (GPU), an image sensor, and/or memory 20 or storage devices 22. Additionally, in some embodiments, image data may be received from another electronic device 10, for example, via the network interface 24 and/or an I/O port 16.

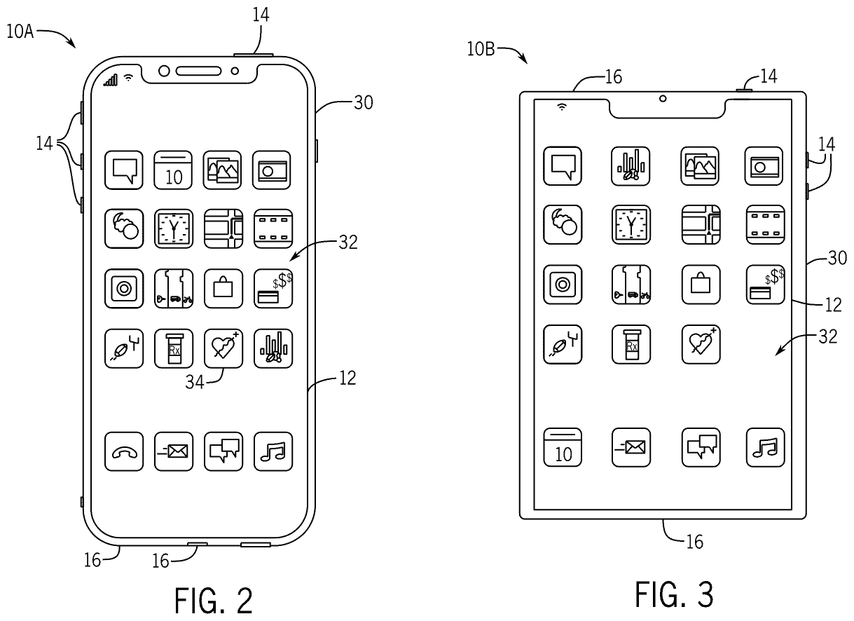

One example of the electronic device 10, specifically a handheld device 10A, is shown in FIG. 2. FIG. 2 is a front view of the handheld device 10A representing an example of the electronic device 10. The handheld device 10A may be a portable phone, a media player, a personal data organizer, a handheld game platform, and/or the like. For example, the handheld device 10A may be a smart phone, such as any iPhone® model available from Apple Inc.

The handheld device 10A includes an enclosure 30 (e.g., housing). The enclosure 30 may protect interior components from physical damage and/or shield them from electromagnetic interference. In the depicted embodiment, the electronic display 12 is displaying a graphical user interface (GUI) 32 having an array of icons 34. By way of example, when an icon 34 is selected either by an input device 14 or a touch sensing component of the electronic display 12, an application program may launch.

Input devices 14 may be provided through the enclosure 30. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. The I/O ports 16 also open through the enclosure 30. The I/O ports 16 may include, for example, a Lightning® or Universal Serial Bus (USB) port.

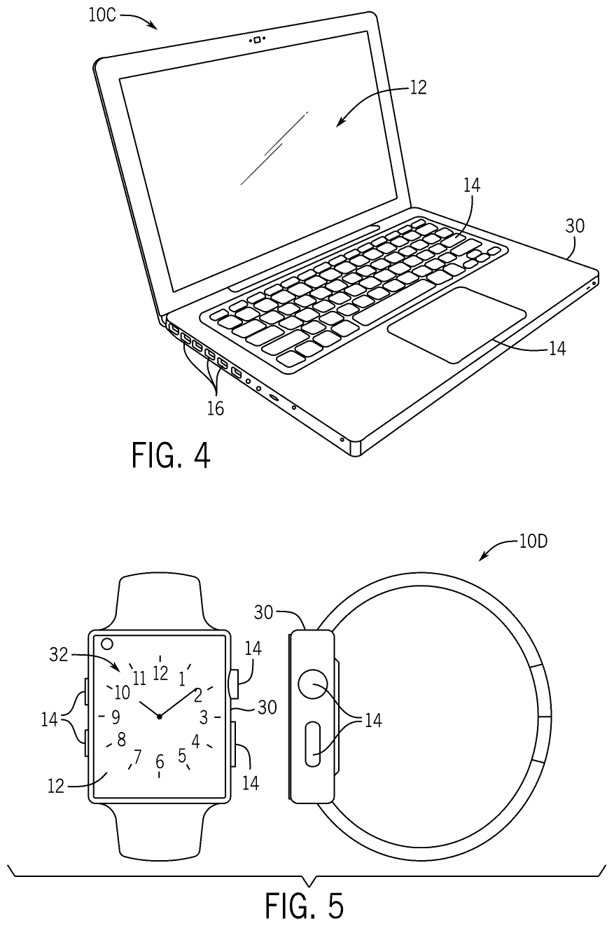

The electronic device 10 may take the form of a tablet device 10B, as shown in FIG. 3. FIG. 3 is a front view of the tablet device 10B representing an example of the electronic device 10. By way of example, the tablet device 10B may be any iPad® model available from Apple Inc. A further example of a suitable electronic device 10, specifically a computer 10C, is shown in FIG. 4. FIG. 4 is a front view of the computer 10C representing an example of the electronic device 10. By way of example, the computer 10C may be any MacBook® or iMac® model available from Apple Inc. Another example of a suitable electronic device 10, specifically a watch 10D, is shown in FIG. 5. FIG. 5 includes front and side views of the watch 10D representing an example of the electronic device 10. By way of example, the watch 10D may be any Apple Watch® model available from Apple Inc. As depicted, the tablet device 10B, the computer 10C, and the watch 10D all include respective electronic displays 12, input devices 14, I/O ports 16, and enclosures 30.

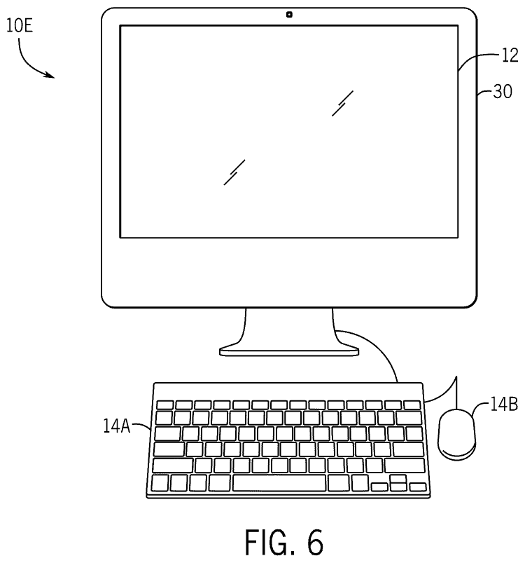

Turning to FIG. 6, a computer 10E may represent another embodiment of the electronic device 10 of FIG. 1. The computer 10E may be any suitable computer, such as a desktop computer or a server, but may also be a standalone media player or video gaming machine. By way of example, the computer 10E may be an IMAC® or other device by Apple Inc. of Cupertino, California. It should be noted that the computer 10E may also represent a personal computer (PC) by another manufacturer. A similar enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

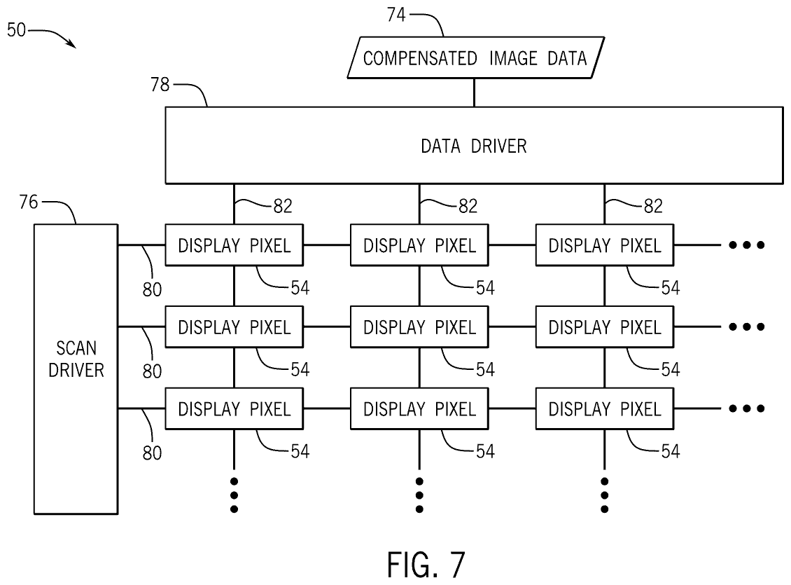

Keeping the foregoing in mind, FIG. 7 is a block diagram of a display pixel array 50 of the electronic display 12. It should be understood that, in an actual implementation, additional or fewer components may be included in the display pixel array 50. The electronic display 12 may receive image data 74 for presentation on the electronic display 12. The electronic display 12 includes display driver circuitry that includes scan driver circuitry 76 and data driver circuitry 78. The display driver circuitry controls programing the image data 74 into the display pixels 54 for presentation of an image frame via light emitted according to each respective bit of image data 74 programmed into one or more of the display pixels 54.

The display pixels 54 may each include one or more self-emissive elements, such as a light-emitting diodes (LEDs) (e.g., organic light emitting diodes (OLEDs) or micro-LEDs (μLEDs)), however other pixels may be used with the systems and methods described herein including but not limited to liquid-crystal devices (LCDs), digital mirror devices (DMD), or the like, and include use of displays that use different driving methods than those described herein, including partial image frame presentation modes, variable refresh rate modes, or the like.

Different display pixels 54 may emit different colors. For example, some of the display pixels 54 may emit red (R) light, some may emit green (G) light, and some may emit blue (B) light. The display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use cyan (C), magenta (M), or others.

The scan driver circuitry 76 may provide scan signals (e.g., pixel reset, data enable, on-bias stress) on scan lines 80 to control the display pixels 54 by row. For example, the scan driver circuitry 76 may cause a row of the display pixels 54 to become enabled to receive a portion of the image data 74 from data lines 82 from the data driver circuitry 78. In this way, an image frame of image data 74 may be programmed onto the display pixels 54 row by row. Other examples of the electronic display 12 may program the display pixels 54 in groups other than by row. In some cases, touch scanning operations may occur while drivers are off or idle (e.g., quiet).

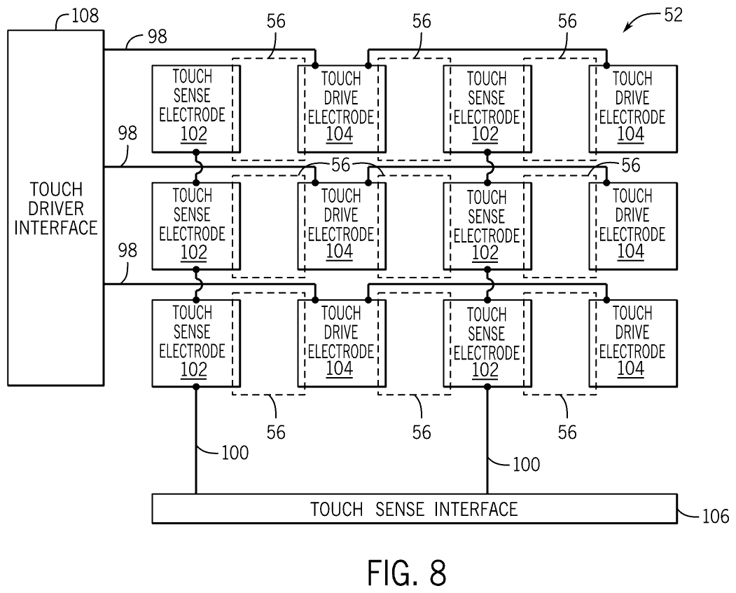

The display pixel array 50 operates differently than the touch sensor array 52. Referring now to operations of the touch sensor array 52, FIG. 8 is a block diagram of the touch sensor array 52 of the electronic display 12. The touch sensor array 52 and the display pixel array 50 may be integrated and disposed onto a same component, a silicon chip, a board, or the like.

The touch sensor array 52 includes touch sense regions 56 (e.g., any sized matrix of touch sense regions 56) formed by interactions between touch drive electrodes 104 driven via conductive lines 98 and touch sense electrodes 102 sensed via conductive lines 100. It should be noted that the terms “lines” and “electrodes” as sometimes used herein simply refers to conductive pathways, and are not intended to be limited to structures that are strictly linear. Rather, the terms “lines” and “electrodes” may encompass conductive pathways that change direction or that have different size, shape, materials, or regions. The touch sense electrodes 102 may be sensed along conductive lines 100 by a touch sense interface 106 while different rows of touch drive electrodes 104 are driven with touch drive signals along the conductive lines 98 from a touch driver interface 108.

The touch sense electrodes 102 may respond differently to the touch drive signals based on a proximity of an object, such as a finger, to the touch sense electrodes 102. In this way, the presence of the object may be “seen” in a touch sense region 56 that may result at an intersection of the touch drive electrode 104 and the touch sense electrode 102. That is, the touch drive electrodes 104 and the touch sense electrodes 102 may form capacitive sensing nodes, or more aptly, the touch sense regions 56. The touch sense electrodes 102 and touch drive electrodes 104 may gather touch sense information when operating in what may be referred to herein as a touch mode of operation.

Though the touch sense electrodes 102 and touch drive electrodes 104 may be supplied the same or substantially similar direct current (DC) bias voltage, different alternating current (AC) voltages may be supplied and/or received on touch sense electrodes 102 and touch drive electrodes 104 at substantially different times in some embodiments. For example, as previously noted, the electronic display 12 may switch between two modes of operation: a display mode of operation and the touch mode of operation. Furthermore, in some touch sensor arrays 52, an AC reference voltage is used as a ground for the touch sensing operations associated with the touch sensor array 52.

### I. Systems and Methods to Reduce or Eliminate Visual Artifacts Due to Cuts in a Metal Mesh

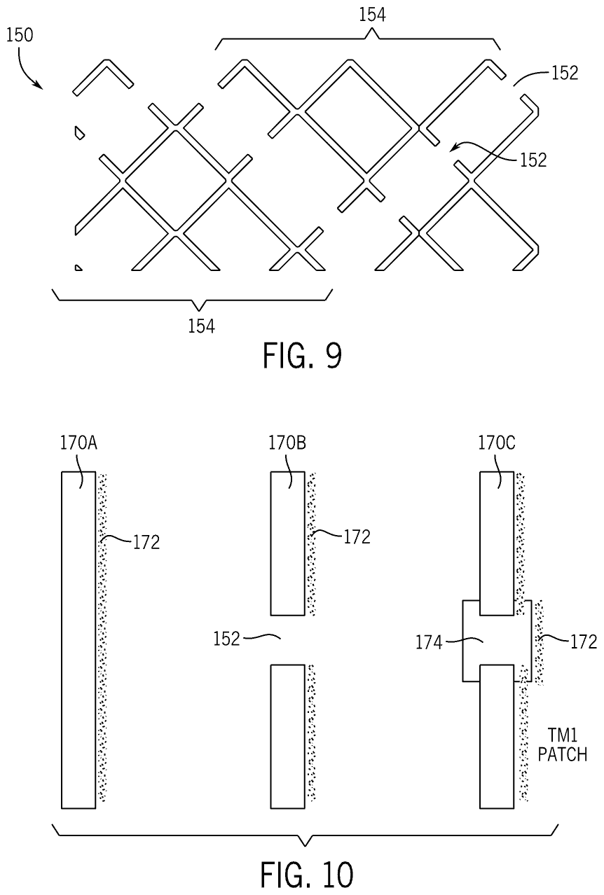

FIG. 9 illustrates a metal mesh 150 with metal mesh cuts (e.g., gaps). The metal mesh 150 may be included in the touch sense electrodes 102 and the touch drive electrodes 104. Cuts 152 in metal mesh 150 may be advantageous as the cuts 152 electrically isolate nets 154 (e.g., network of conductive lines, portions of the metal mesh) in the touch active area. However, the cuts 152 in the metal mesh 150 may result in visible front-of-screen issues for a user of the electronic device 10, as less light is reflected at the location of the cuts 152, causing a differential between the light reflected from the metal of the metal mesh 150 and the cuts 152. This front-of-screen issue caused by the reflected light differential may negatively impact user experience.

FIG. 10 illustrates a touch metal layer 2 (TM2) trace with a touch metal layer 1 (TM1) patch disposed beneath to reduce the reflected light differential, according to embodiments of the present disclosure. The touch sense electrodes 102 described with respect to FIG. 8 may be formed with multiple layers of metal meshes 150 stacked one on top of another. For example, the touch metal layer 2 (TM2) may be disposed above the touch metal layer 1 (TM1). As may be observed, a TM2 trace 170A with no cuts may reflect a uniform amount of reflected light 172 (e.g., an average amount of reflected light per unit area) across the length of the TM2 trace 170A. However, a TM2 trace 170B with a cut 152 may produce a reflected light differential (e.g., a differential in the average amount of reflected light per unit area), as the cut 152 will reflect no light, causing a dark patch that may be visible to a user as the reflected light 172 is broken up. To reduce the reflected light differential and enhance the uniformity of the reflected light 172, a patch made of the TM1 metal (e.g., a TM1 patch 174) may be disposed beneath the cut 152 in the TM2 trace 170C to enhance the uniformity of the reflected light (e.g., making the reflected light uniform or near-uniform by increasing the average amount of reflected light per unit area at the location of the cut 152) which may reduce or eliminate any front-of-screen issue due to a reflected light differential. The TM2 traces 170A, 170B, and 170C may be referred to collectively as the TM2 traces 170.

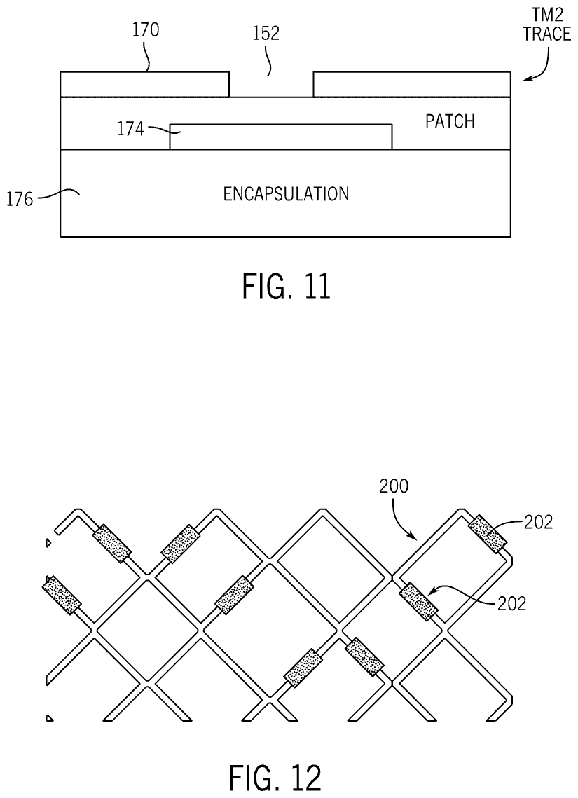

FIG. 11 is a diagram illustrating a side view of the TM1 patch 174 disposed beneath the cut in the TM2 trace 170, according to embodiments of the present disclosure. As may be observed, the TM1 patch 174 may be disposed beneath the cut 152 in the TM2 trace 170 and above an encapsulation layer 176.

In addition to placing patches of a different metal beneath the metal mesh 150, patches of a higher-layer metal may be placed above a lower-layer metal mesh. FIG. 12 illustrates a TM1 mesh 200 having a TM2 patch 202 disposed above the TM1 mesh 200 to enhance reflected light uniformity for the TM1 mesh 200, according to embodiments of the present disclosure. Disposing the TM2 patch 202 above the TM1 mesh 200 may reduce or eliminate a reflected light differential caused by the cuts 152 in the TM1 mesh 200, enhancing the uniformity of the reflected light across the TM1 mesh 200 and reducing or eliminating the front-of-screen artifacts caused by the reflected light differential, as described with respect to FIGS. 9-11 above.

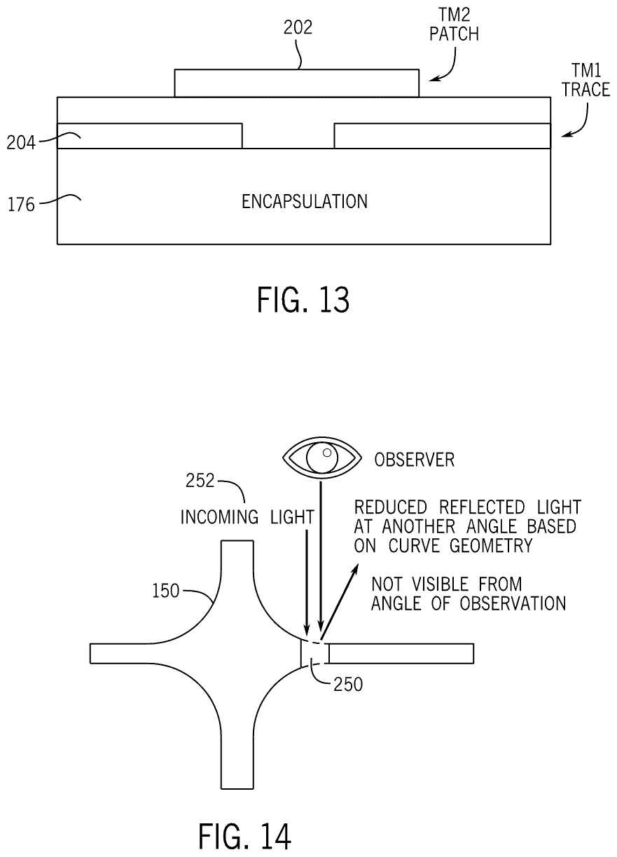

FIG. 13 is a diagram illustrating a side view of the TM2 patch 202 disposed above the cut in a TM1 trace 204 of the TM1 mesh 200, according to embodiments of the present disclosure. The TM2 patch 202 may reflect light at a similar angle and intensity to that of the TM1 trace 204, reducing or eliminating the visual screen artifacts caused by a reflected light differential due to the cut 152 in the TM1 trace 204. In this manner, disposing the TM2 patch 202 above the cut 152 in the TM1 trace 204 may improve the experience of a user. It should be noted that the TM1 patch 174 disposed below the TM2 trace 170 may in some scenarios be combined with the TM2 patch 202 disposed above the TM1 trace 204.

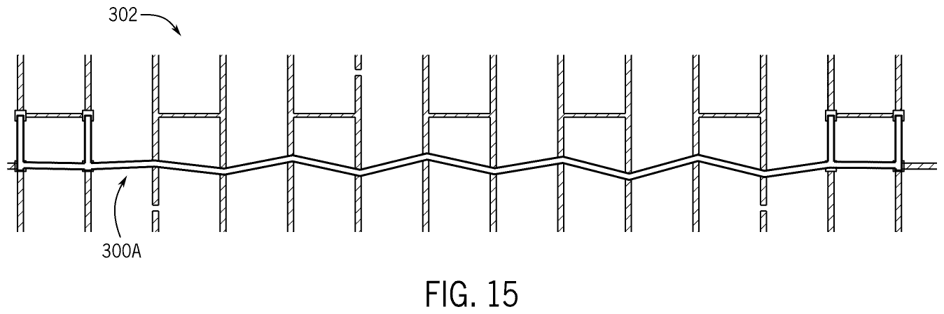

As illustrated above (e.g., with respect to FIG. 9), cuts may be made on straight portions of the metal traces in the metal mesh 150 (e.g., in the nets 154 of the metal mesh 150). However, making the cuts on the straight portion of the metal traces may cause the light reflected off of the metal trace (and the absence of reflected light caused by the cut 152) to be normal (e.g., orthogonal) to the user's line of sight. This may result in a screen artifact visible to the user and may negatively impact user experience. In some embodiments, cuts 152 may be made on a curved edge at a juncture in the metal mesh 150, which may scatter or redirect the reflected light away from the user's direct line of sight, reducing or eliminating the visual screen artifacts observable by the user. FIG. 14 illustrates a corner cut made onto a curved portion of the metal mesh 150 to reduce or eliminate a visible screen artifact, according to embodiments of the present disclosure. A corner cut 250 may scatter the incoming light 252 to non-normal (e.g., non-orthogonal) angles, reducing the reflected light received by the observer. In this manner, the corner cut 250 may reduce the front-of-screen artifact viewable by the user. It should be noted that the corner cut 250 may be used in combination with the TM1 patch 174 and/or the TM2 patch 202 to further reduce or minimize the visual artifacts caused by the cuts 152.

### II. Systems and Methods to Reduce or Eliminate Visual Artifacts Due to a Bridge

A bridge on a first metal layer (e.g., TM2/TM1) may be disposed across a sensor mesh on a second metal layer (e.g., TM1/TM2). In some instances, the bridge may appear brighter or darker than the sensor mesh on the second metal layer, and thus the bridge may be visible to a user of the electronic device 10. If the bridge is disposed in a straight line across the sensor mesh, the bridge may reflect all incident light in the same direction. When the incident light is reflected in the direction of the user, the user may perceive an unwanted visual artifact. To reduce or eliminate this visual artifact, a curved bridge may be implemented.

FIG. 15 is a diagram of a sensor mesh of a first metal layer and a curved bridge of a second metal layer, according to embodiments of the present disclosure. A curved bridge 300A on a first metal layer (e.g., TM2/TM1) may be disposed across a sensor mesh 302 (e.g., the TM1 mesh 200, a TM2 mesh) of a second metal layer (e.g., TM1/TM2). The curved bridge may be curved (e.g., angled in piecewise segments, curved in smooth curved segments) up and down in an alternating pattern across the sensor mesh 302. The angle at which the curved portions of the curved bridge 300A are angled up and down may vary across the length of the curved bridge 300A or may remain constant across the sensor mesh 302. For example, the curved bridge 300A may be adjusted to angle 45 degrees in a first direction and 45 degrees in a second direction in an alternating pattern across the sensor mesh 302. While 45-degrees is used here, this is merely illustrative and it should be noted that any appropriate angle (e.g., 10 degrees or more, 20 degrees or more, 50 degrees or more) may be applied. In another example, the curved bridge 300A may be adjusted to angle in the first direction and the second direction at varying (e.g., irregular, random) angles across the sensor mesh 302. For example, the curved bridge 300A may be adjusted to angle 45 degrees in the first direction for a portion, then may be angled 30 degrees in the second direction for a second portion, and angled in the first direction again at an angle of 50 degrees for a third portion. In this manner, the curved bridge 300A may reflect incident light in a variety of directions not directly in the line of sight of the user, reducing or eliminating a visual artifact due to the reflections off of the curved bridge 300A.

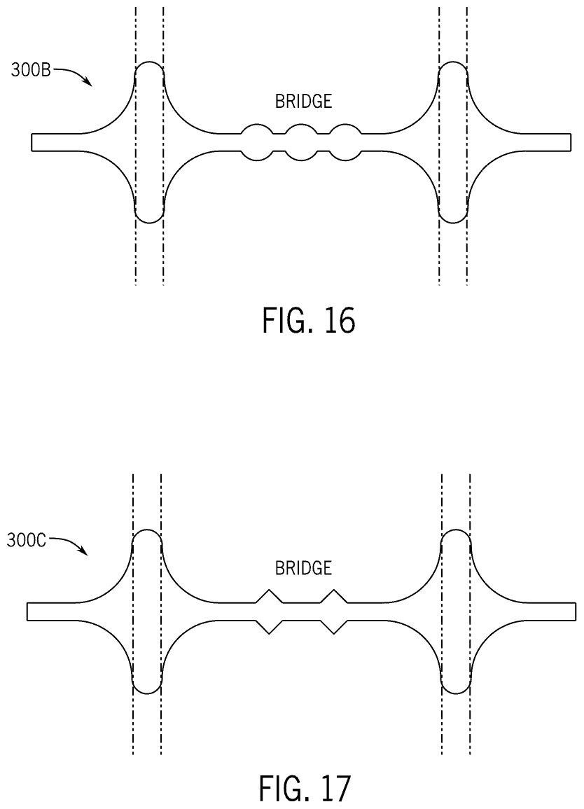

It should be noted that the geometry of the curved bridge 300A may be changed in a number of different ways to disperse reflected light away from the viewing angle of the user. The bridge may be curved with sharp or shallow angles to include a variety of shapes. FIG. 16 illustrates a curved bridge 300B having curves with a circular geometry, according to an embodiment of the present disclosure. The circular geometry of the curved bridge 300B may disperse reflected light away from the viewing angle of the user, as described with respect to FIG. 15. FIG. 17 illustrates a curved bridge 300C having curves with an angular geometry, according to an embodiment of the present disclosure. The curved bridges 300A, 300B, and 300C may collectively be referred to as the curved bridges 300. It should be noted that any of the curved bridges 300 described above may be used in combination with the corner cut 250, the TM1 patch 174 and/or the TM2 patch 202 to further reduce or minimize the visual artifacts perceived by the user of the electronic device 10.

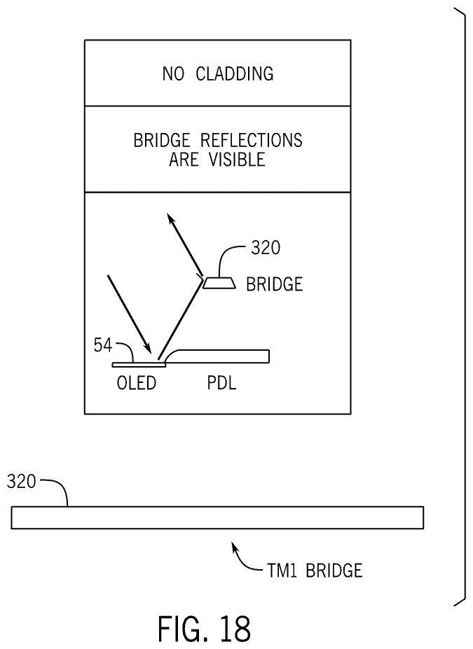

In other embodiments, the off-state visibility (e.g., bright or dark appearance) of a bridge may be reduced or eliminated by cladding (e.g., covering) an underlying extra metal mesh. FIG. 18 is a diagram illustrating how reflected light from an uncladded (e.g., uncovered) TM1 bridge 320 may be visible to a user. Incoming light may be reflected off of a display pixel 54 towards the TM1 bridge 320, and further reflected off of the TM1 bridge 320 towards the user. The reflection from the TM1 bridge 320 to the user may create a visual artifact that negatively impacts user experience.

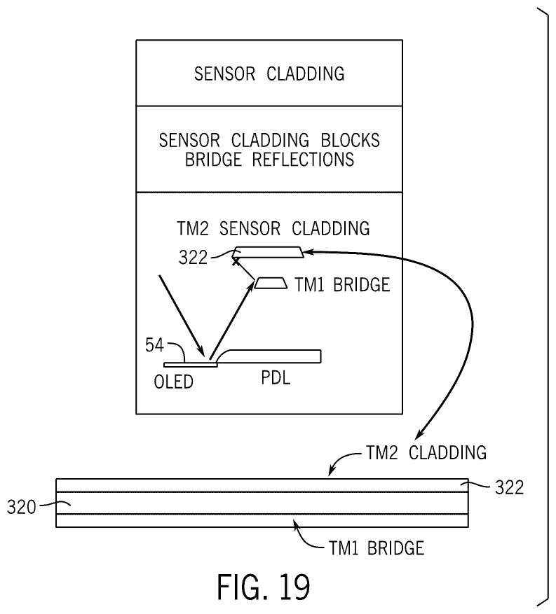

FIG. 19 is a diagram illustrating how reflected light off of a bridge may be reduced or eliminated by cladding, according to embodiments of the present disclosure. As may be observed, the incoming light reflected off of the display pixel 54 is reflected towards the TM1 bridge 320, and reflected off of the TM1 bridge 320 as illustrated with respect to FIG. 18. However, TM2 cladding 322 disposed above the TM1 bridge 320 may block at least a portion of the light from being reflected towards the user. As the TM2 cladding 322 blocks the light reflected from the TM1 bridge 320, the visual artifact experienced by the user may be reduced or eliminated.

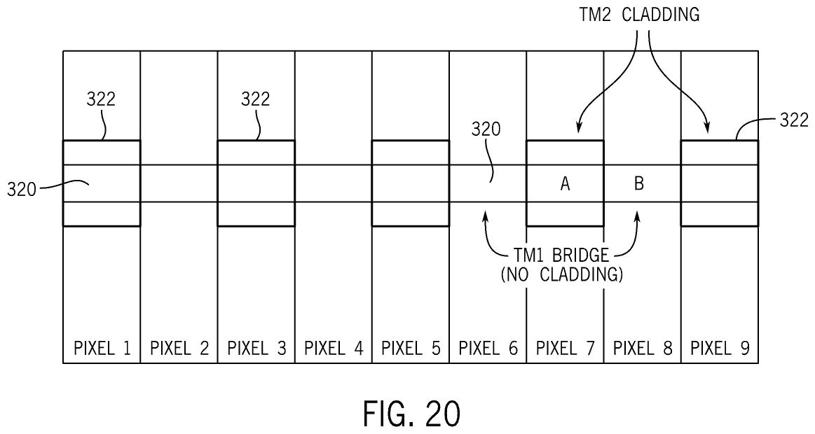

FIG. 20 is a diagram illustrating a top view of the TM2 cladding 322 disposed over the TM1 bridge 320, according to embodiments of the present disclosure. As may be observed, in some embodiments, the TM2 cladding 322 may be disposed over the TM1 bridge 320 at alternating pixels to reduce the amount of TM2 metal used for cladding, and to blend the effect of the cladding. For example, the TM2 cladding 322 may be disposed over the TM1 bridge 320 at odd numbered pixels (e.g., Pixel 1, Pixel 3, Pixel 5, and so on) while there is no TM2 cladding 322 over even numbered pixels (e.g., Pixel 2, Pixel 4, Pixel 6, and so on), or vice versa. This cladding pattern may reduce or eliminate visual artifacts from light reflected off of the TM1 bridge 320 (e.g., as described with respect to FIGS. 19-20) while preventing excess metal from being disposed in the TM2 layer.

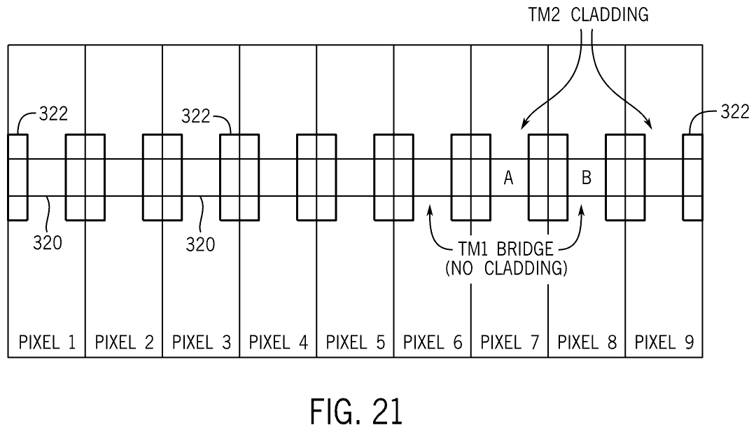

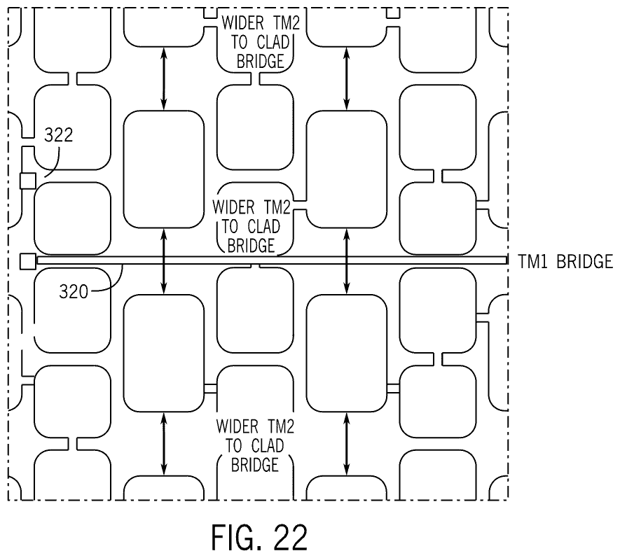

FIG. 21 is a diagram illustrating another top view of the TM2 cladding 322 disposed over the TM1 bridge 320, according to embodiments of the present disclosure. In some embodiments, the TM2 cladding 322 may be disposed over the TM1 bridge 320 for a portion of each touch pixel. For example, the TM2 cladding 322 may be disposed over each touch pixel at a transition region between touch pixels. As illustrated in FIG. 21, the TM2 cladding 322 may be disposed at the transition region of Touch Pixel 1 and Touch Pixel 2, followed by a portion of the TM1 bridge 320 with no cladding. Another portion of the TM2 cladding 322 may be disposed at the transition region between Touch Pixel 2 and Touch Pixel 3, followed by another portion of the TM1 bridge 320 with no cladding, and so on. This cladding pattern may reduce or eliminate visual artifacts from light reflected off of the TM1 bridge 320 (e.g., as described with respect to FIGS. 18-19) while preventing excess metal from being disposed in the TM2 layer.

FIG. 22 is a diagram illustrating cladding disposed across the electronic display, not merely over portions of the TM1 bridge, according to embodiments of the present disclosure. As may be appreciated, disposing the TM2 cladding 322 across the electronic display 12 may provide robust covering of the TM1 bridge 320, reducing or minimizing the off-state viewability of the TM1 bridge 320. It should be noted that any of the cladding methods described above may be used in combination with the curved bridges 300, the corner cut 250, the TM1 patch 174 and/or the TM2 patch 202 to further reduce or minimize the visual artifacts perceived by the user of the electronic device 10.

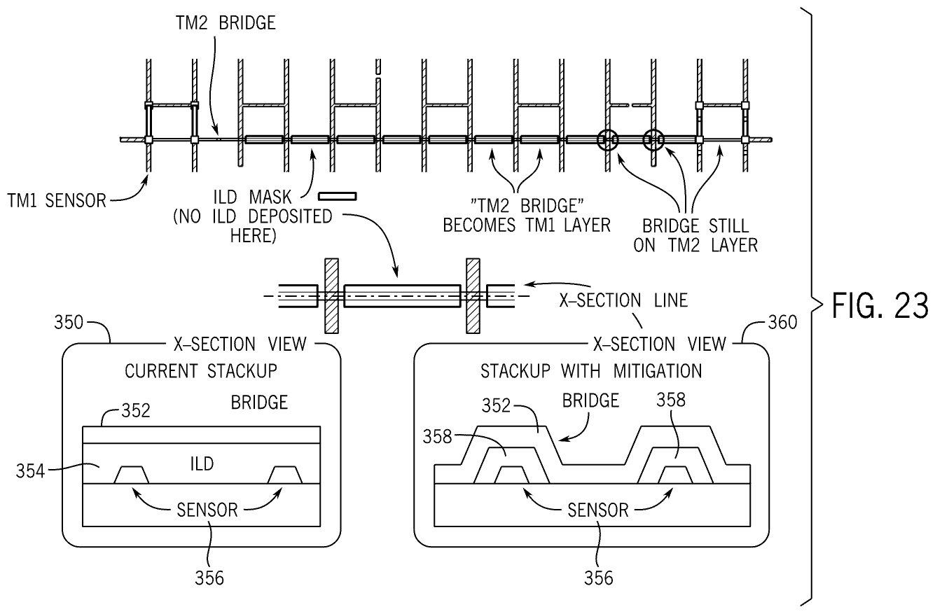

Off-state visibility of a TM2 bridge may be caused by contrast between the TM2 bridge and a sensor on the TM1 layer. In some embodiments, to reduce the visibility of the TM2 bridge, the TM2 bridge may be moved to the TM1 layer to reduce this contrast. FIG. 23 is a diagram illustrating a patterned inter-layer dielectric (ILD) disposed beneath TM2 bridge to bring the TM2 bridge onto the TM1 metal layer, reducing or eliminating a bright off-state appearance of the TM2 bridge, according to embodiments of the present disclosure. In a cross-sectional view 350, a TM2 bridge 352 may be disposed over an unpatterned ILD 354, which is disposed over touch sensors 356. However, in this architecture, the TM2 bridge 352 may appear bright in an off-state of the electronic display 12.

To reduce or mitigate this bright off-state appearance of the TM2 bridge 352, a patterned ILD 358 may be disposed beneath the TM2 bridge 352, as illustrated in the cross-sectional view 360. In the cross-sectional view 360, the patterned ILD 358 is conformally deposited over the sensors 356 such that the patterned ILD 358 takes on the shape of the sensors. The TM2 bridge 352 is deposited conformally over the patterned ILD 358, resulting in the TM2 bridge 352 taking on the shape of the sensors 356 and the patterned ILD 358. This may move the TM2 bridge 352 to the TM1 layer, which may reduce or eliminate the contrast between the TM2 bridge 352 and a TM1 sensor 356 and thus reduce or eliminate the off-state visibility of the TM2 bridge 352. It should be noted that the patterned ILD 358 described above may be used in combination with any of the cladding methods, the curved bridges 300, the corner cut 250, the TM1 patch 174 and/or the TM2 patch 202 to further reduce or minimize the visual artifacts perceived by the user of the electronic device 10.

### III. Systems and Methods to Reduce or Eliminate Visual Artifacts Due to Functional Vias

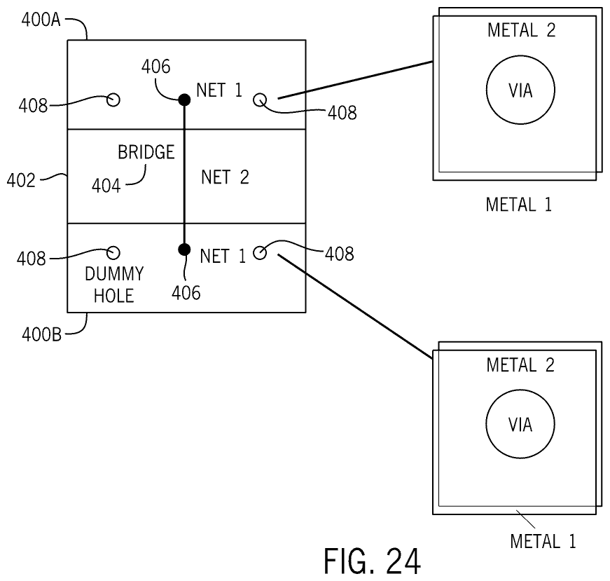

In electronic display sensor meshes, multiple nets 154 (e.g., multiple portions of nets) may be coupled together by vias and bridges. For example, a net 154 may include a portion of the metal mesh 150 that may form the touch sense electrode 102 or the touch drive electrode 104. The bridge (e.g., the TM1 bridge 320) may include a wire that connects the touch sense electrode 102 to another touch sense electrode 102, or that connects the touch drive electrode 104 to another touch drive electrode 104. However, the vias may appear visible (e.g., brighter, darker) than the nets on which they are disposed, and as such may result in an unwanted artifact visible to the user. To reduce or eliminate this visible artifact, dummy (i.e., non-functional) vias and/or dummy holes may be implemented on the nets. The dummy vias and/or dummy holes may serve only to reflect light in a manner similar to the light reflected by the functional vias or holes to create a more uniform appearance. With this in mind, FIG. 24 is a diagram illustrating the implementation of dummy vias to reduce or eliminate the appearance of visual artifacts due to functional vias, according to embodiments of the present disclosure. A first portion of a first net 400A and a second portion of the first net 400B (collectively referred to herein as the first net 400) may be separated by a second net 402. To connect the first portion of the first net 400A and the second portion of the first net 400B, a bridge 404 and vias 406 (e.g., functional vias) may be implemented, such that a via 406 is disposed on a first portion of the first net 400A and another via 406 is disposed on the second portion of the first net 404B, and the vias are coupled by the bridge 404.

As previously mentioned, the vias 406 may appear bright or dark, causing a visible artifact viewable by the user. To create more uniform appearance and reduce or eliminate the visual artifacts due to the appearance of the vias 406, dummy vias (e.g., non-functional vias) 408 may be disposed on the first portion of the first net 404A and the second portion of the first net 404B to camouflage the vias 406.

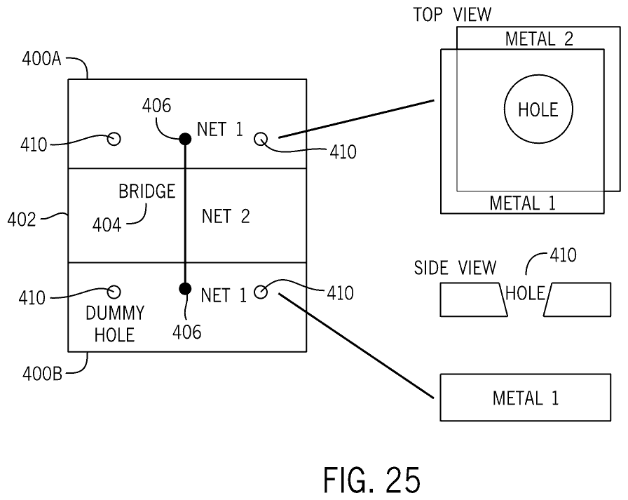

FIG. 25 is a diagram illustrating the implementation of dummy holes to reduce or eliminate the appearance of visual artifacts due to functional vias, according to embodiments of the present disclosure. As mentioned with respect to FIG. 18, the vias 406 may appear bright or dark, causing a visible artifact viewable by the user. To create more uniform appearance and reduce or eliminate the visual artifacts due to the appearance of the vias 406, dummy holes (e.g., non-functional holes) 410 may be disposed on the first portion of the first net 400A and the second portion of the first net 400B to camouflage the vias 406. The dummy holes 410 may have similar sidewall reflections to the vias 406 and may be used along with or instead of the dummy vias 408. It should be noted that the dummy vias 408 and dummy holes 410 may be used in combination together and/or with the patterned ILD 358, any of the cladding methods, the curved bridges 300, the corner cut 250, the TM1 patch 174 and/or the TM2 patch 202 to further reduce or minimize the visual artifacts perceived by the user of the electronic device 10.

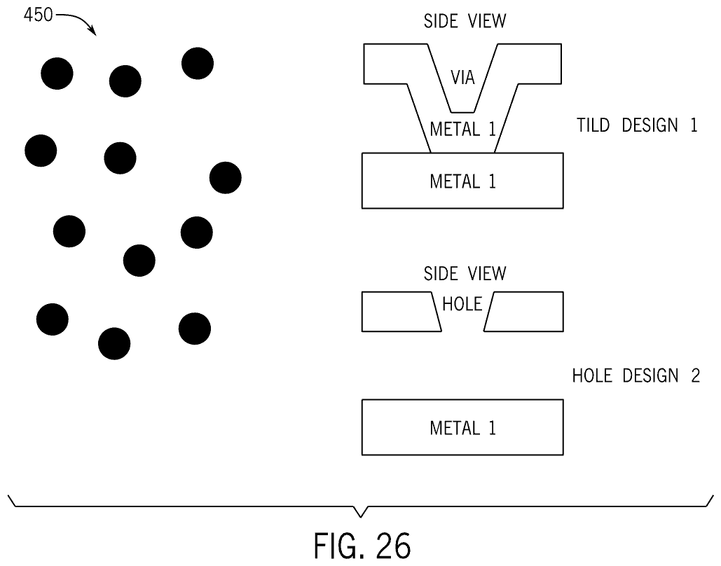

Vias may be disposed in a border of an active area of the electronic device 10 (e.g., near an inactive area of the electronic device 10) to make the border brighter, reducing a visible artifact caused by the border of the metal layer being darker than the rest of the metal layer. However, disposing the vias in a regular pattern such that the vias are evenly spaced in rows and columns may result in an undesirable diffraction pattern viewable to the user. To reduce or eliminate the diffraction pattern, the vias may be disposed in random or irregular patterns throughout the border. FIG. 26 illustrates an irregular pattern 450 (e.g., a non-uniform pattern, a randomized pattern) of vias disposed at the active area border and the inactive area of the electronic device 10, according to embodiments of the present disclosure. Disposing the vias in the irregular pattern 450 in the border of the metal layer may enhance brightness in the border and reduce or eliminate any diffraction pattern associated with the vias in the border region. It should be noted that, as shown in FIG. 26, holes may be disposed in the border of the metal layer in combination with or instead of vias. The holes and vias disposed in the border may include functional vias, non-functional vias (e.g., dummy vias 408), functional holes or non-functional holes (e.g., the dummy holes 410), or any combination thereof. It should be noted that the placement of the vias in the irregular pattern 450 at the boarder may be used in combination with dummy vias 408 and dummy holes 410, the patterned ILD 358, any of the cladding methods, the curved bridges 300, the corner cut 250, the TM1 patch 174 and/or the TM2 patch 202 to further reduce or minimize the visual artifacts perceived by the user of the electronic device 10.

Technical effects include using the described systems and methods to improve user viewing experience by reducing or eliminating visual artifacts caused by reflectivity differentials associated with a touch subsystem of the electronic device 10.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Furthermore, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic display, comprising:
a metal mesh disposed on a first metal layer, the metal mesh comprising a plurality of nets and plurality of cuts in the metal mesh configured to electrically separate the plurality of nets from one another in a touch active area, wherein the plurality of nets at least partially comprises a plurality of metal traces; and
a metal patch disposed on a second metal layer over each cut of the plurality of cuts such that the metal patch reflects ambient light over each cut of the plurality of cuts.

2. The electronic display of claim 1, comprising another metal mesh disposed on the second metal layer, the other metal mesh comprising another plurality of nets and another plurality of cuts configured to electrically separate the other plurality of nets in the touch active area.

3. The electronic display of claim 2, comprising another metal patch disposed on the first metal layer under each cut of the other plurality of cuts such that the other metal patch reflects ambient light over each cut of the other plurality of cuts.

4. The electronic display of claim 1, wherein the plurality of cuts in the metal mesh are disposed on a curved or angled edge of a juncture of the metal mesh.

5. The electronic display of claim 1, comprising a bridge disposed on the second metal layer, the bridge disposed such that the bridge comprises an angled geometry, wherein a first portion of the bridge is angled in a first direction and a second portion of the bridge is angled in a second direction.

6. The electronic display of claim 1, comprising:
a bridge disposed over a first touch pixel, a second touch pixel, a third touch pixel, and a fourth touch pixel on the first metal layer, and
metal cladding disposed over at least a portion of the bridge on the second metal layer to reduce a reflection of ambient light off of the bridge.

7. The electronic display of claim 6, wherein the metal cladding is disposed only over a first portion of the bridge corresponding to the first touch pixel and a second portion of the bridge corresponding to the third touch pixel.

8. The electronic display of claim 6, wherein the metal cladding is disposed over:
a first portion of the bridge corresponding to a first transitional region between the first touch pixel and the second touch pixel;
a second portion of the bridge corresponding to a second transitional region between the second touch pixel and the third touch pixel; and
a third portion of the bridge corresponding to a transitional region between the third touch pixel and the fourth touch pixel.

9. The electronic display of claim 6, wherein the metal cladding is disposed over the entirety of the bridge.

10. An electronic display, comprising:
a plurality of touch pixels;
a bridge disposed on a first metal layer over the plurality of touch pixels; and
metal cladding disposed over at least a portion of the bridge on a second metal layer to reduce a reflection of ambient light off of the bridge.

11. The electronic display of claim 10, wherein the metal cladding is disposed only over a first portion of the bridge corresponding to alternating touch pixels of the plurality of touch pixels.

12. The electronic display of claim 10, wherein the metal cladding is disposed over:
a first portion of the bridge corresponding to a first transitional region between a first touch pixel and a second touch pixel;
a second portion of the bridge corresponding to a second transitional region between the second touch pixel and a third touch pixel; and
a third portion of the bridge corresponding to a transitional region between the third touch pixel and a fourth touch pixel.

13. The electronic display of claim 10, wherein the metal cladding is disposed over the entirety of the bridge.

14. The electronic display of claim 10, wherein the bridge is formed such that the bridge comprises an angled geometry wherein a first portion of the bridge is angled in a first direction and a second portion of the bridge is angled in a second direction.

15. The electronic display of claim 10, comprising:
a metal mesh disposed on the first metal layer, the metal mesh comprising a plurality of cuts; and
a metal patch disposed on the second metal layer over each cut of the plurality of cuts such that the metal patch reflects ambient light over each cut of the plurality of cuts.

16. The electronic display of claim 15, wherein the plurality of cuts in the metal mesh are disposed on a curved edge of a juncture of the metal mesh.

17. An electronic display, comprising:
a first network of conductors comprising a first portion and a second portion;
a second network of conductors disposed between the first portion and the second portion;
a first via disposed in the first portion;
a second via disposed in the second portion; and
a plurality of non-functional vias disposed across the first portion and the second portion to reduce non-uniform reflectivity caused by the first via and the second via.

18. The electronic display of claim 17, comprising a plurality of non-functional holes disposed across the first portion and the second portion to reduce non-uniform the non-uniform reflectivity caused by the first via and the second via.

19. The electronic display of claim 17, comprising an active area and an inactive area, wherein a plurality of vias are disposed in an irregular pattern at a border of the active area and the inactive area.

20. The electronic display of claim 19, wherein a first set of the plurality of vias comprise non-functional vias and a second set of the plurality of vias comprise functional vias.
